(19) United States
(12) Patent Application Publication
(10) Pub. No.: US 2022/0239628 A1
(43) Pub. Date: Jul. 28, 2022

(54) MANAGING INTERNET PROTOCOL (IP) ADDRESS DETECTION WITH A SYSTEM MANAGEMENT CONSOLE

(71) Applicant: Dell Products L.P., Round Rock, TX (US)

(72) Inventors: Balaji Singh Bondhili, Bangalore (IN); Santosh Hanamant Gore, Bangalore (IN); Raveendra Babu Madala, Bangalore (IN)

(21) Appl. No.: 17/155,398

(22) Filed: Jan. 22, 2021

(51) Int. Cl. H04L 29/12

(52) U.S. Cl. CPC H04L 61/2076; H04L 61/6022; H04L 61/2015

(57) ABSTRACT

Managing IP address detection, including obtaining, by system management console that manages multiple computing systems, a media access control (MAC) address of each of the computing systems from a respective baseboard management controller (BMC) of each of the computing systems; storing a database table indicating the MAC address for each of the computing systems; identifying, from a host network, messages directed to the computing systems; obtaining, from each of the messages, a MAC address associated with the message; comparing the MAC address for a particular message with the MAC addresses stored by the database table for each of the computing systems; determining whether the MAC address for the particular message is associated with a particular computing system; when it is determined that the MAC address for the particular message is associated with a computing system, providing the IP address indicated by the message to the BMC of the computing system.

### BACKGROUND

### Field of the Disclosure

The disclosure relates generally to an information handling system, and in particular, managing internet protocol (IP) address detection of information handling systems.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

Innovative aspects of the subject matter described in this specification may be embodied in method of managing internet protocol (IP) address detection, the method including obtaining, by a system management console that manages multiple computing systems, a media access control (MAC) address of each of the computing systems from a respective baseboard management controller (BMC) of each of the computing systems; storing, by the system management console, a database table indicating the MAC address for each of the computing systems; identifying, from a host network, one or more messages directed to one or more of the computing systems, each message indicating an IP address; obtaining, from each of the messages, a MAC address associated with the message; comparing, by the system management console, the MAC address for a particular message of the one or more messages with the MAC addresses stored by the database table for each of the computing systems; determining, based on the comparing, whether the MAC address for the particular message is associated with a particular computing system of the multiple computing systems managed by the system management console; and when it is determined that the MAC address for the particular message is associated with a computing system managed by the system management console, providing the IP address indicated by the message to the BMC of the computing system.

Other embodiments of these aspects include corresponding systems, apparatus, and computer programs, configured to perform the actions of the methods, encoded on computer storage devices.

These and other embodiments may each optionally include one or more of the following features. For instance, the one or more messages are unicast messages directed to the one or more of the computing systems, are broadcast message directed to the one or more computing systems, or both. After determining that the MAC address for the particular message is associated with a computing system managed by the system management console, accessing the computing system associated with the MAC address. When it is determined that the MAC address for the particular message is not associated with a computing system managed by the system management console, discarding the message. The messages are dynamic host configuration protocol (DHCP) messages. Updating the database table to indicate the IP address for the computing system. Updating the BMC of the computing system to indicate the IP address.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing internet protocol (IP) address detection.

FIG. 3 illustrates a method for managing internet protocol (IP) address detection.

### DESCRIPTION OF PARTICULAR EMBODIMENT(S)

This disclosure discusses methods and systems for managing internet protocol (IP) address detection. In short, an information handling system (system management console) can facilitate management of internet protocol (IP) address detection for computing systems of a computing system cluster. Specifically, the information handling system can perform IP address detection for the computing systems without performing an inventory of the computing systems by a host server. In short, the system management console can “listen” to DHCP messages from the host server that are related to the computing systems for detecting host IP address. The system management console can detect such IP addresses, and provide such information to the broadband management controllers (BMCs) of the computing systems. The system management console can further update the host IP address information at the BMCs (when a change in IP address is detected).

Specifically, this disclosure discusses a system and a method for managing internet protocol (IP) address detection, including, obtaining, by a system management console that manages multiple computing systems, a media access control (MAC) address of each of the computing systems from a respective baseboard management controller (BMC) of each of the computing systems; storing, by the system management console, a database table indicating the MAC address for each of the computing systems; identifying, from a host network, one or more messages directed to one or more of the computing systems, each message indicating an IP address; obtaining, from each of the messages, a MAC address associated with the message; comparing, by the system management console, the MAC address for a particular message of the one or more messages with the MAC addresses stored by the database table for each of the computing systems; determining, based on the comparing, whether the MAC address for the particular message is associated with a particular computing system of the multiple computing systems managed by the system management console; and when it is determined that the MAC address for the particular message is associated with a computing system managed by the system management console, providing the IP address indicated by the message to the BMC of the computing system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

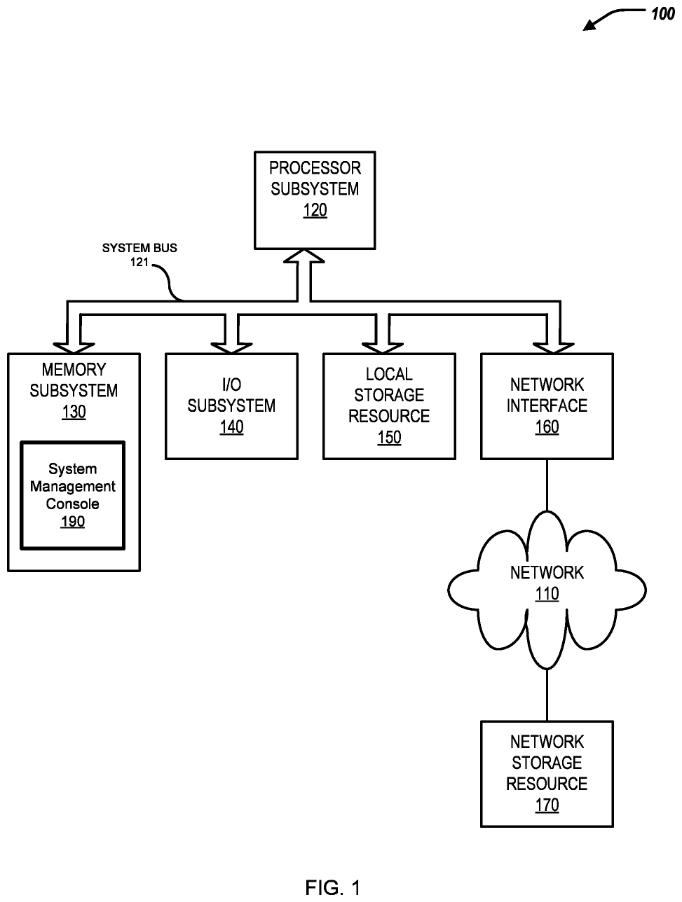

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, or a camera, or another type of peripheral device.

Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other type of rotating storage media, flash memory, EEPROM, and/or other type of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g. corporate) network. The network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g. customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

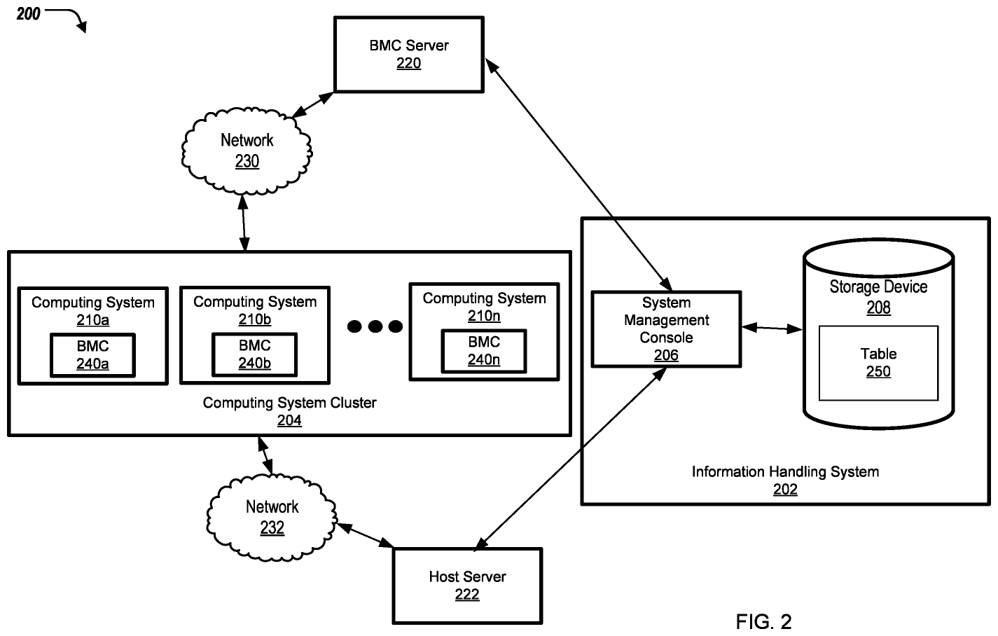

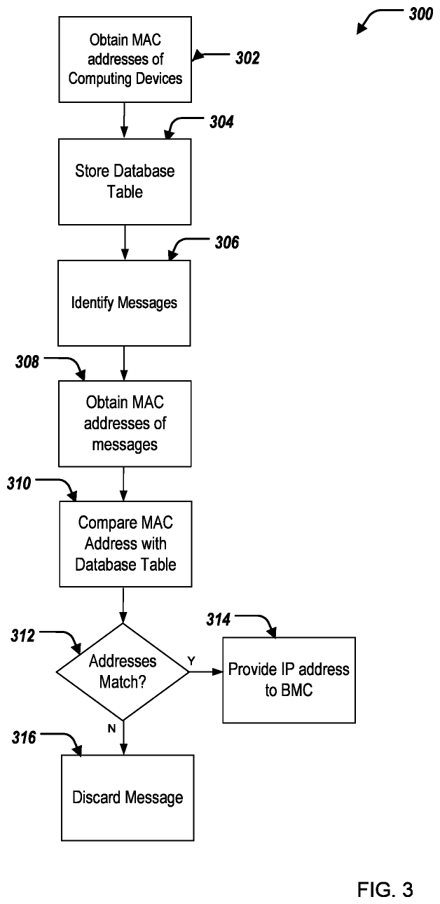

The information handling system 100 can also include a system management console 190. The system management console 190 can be included by the memory subsystem 130. The system management console 190 can include a computer-executable program (software). The system management console 190 can be executed by the processor subsystem 120. The operation of the system management console 190 with be described further herein with reference to FIGS. 2 and 3.

Turning to FIG. 2, FIG. 2 illustrates an environment 200 including an information handling system 202 and a computing system cluster 204. The information handling system 202 can include a system management console 206 and a storage device 208. In some examples, the IHS 202 is similar to, or includes, the information handling system 100 of FIG. 1. In some examples, the system management console 206 is the same, or substantially the same, as the system management console 206 of FIG. 1.

The computing system cluster 204 can include one or more computing systems 210a, 210b, . . . , 210n (collectively referred to as computing systems 210), depending on the application desired. Each of the computing systems 210a, 210b, . . . , 210n can include a respective broadband management controller (BMC) 240a, 240b, . . . , 240n (collectively referred to as BMCs 240). In some examples, the computing systems 210 can include respective remote access controllers (out-of-band management platform) such as an integrated Dell Remote Access Controller (iDRAC).

The environment 200 can further a broadband management controller (BMC) server 220 and a host server 222. The BMC server 220 can be in communication with the computing system cluster 204 over a first network 230. For example, the BMC server 220 can be in communication with respective BMCs 240 of the computing systems 210. The host server 222 can be in communication with the computer system cluster 204 over a second network 232 (the second network 232 differing from the first network 230).

The information handling system 202, and specifically, the system management console 206, can be in communication with the BMC server 220 and the host server 222.

The system management console 206 can include an OpenManage Enterprise (OME) console, or any system management console that can access both the BMC (management) server 220 (through the first network 230) and the host server 222 (through the second network 232).

In some examples, each of the BMC server 220 and the host server 222 are dynamic host configuration protocol (DHCP) servers. In some examples, the BMC server 220 and the host server 222 are separate DHCP servers. In some examples, the BMC server 220 and the host server 222 are a single DHCP server.

To that end, the information handling system 202, and specifically, the system management console 206, can facilitate management of internet protocol (IP) address detection for the computing systems 210 of the computing system cluster 204. Specifically, the system management console 206 can perform IP address detection for the computing systems 210 without the host server 222 performing/conducting an inventory of the computing systems 210. In short, the system management console 206 can “listen” to DHCP messages that are transmitted from the host server 222 and are related to the computing systems 210 for detecting host IP addresses for the computing systems 210. The system management console 206 can detect such IP addresses, and provide the IP address information to the respective BMCs 240 of the computing systems 210. The system management console 206 can further update the host IP address information at the BMCs 240 (e.g., when a change in IP address is detected).

As a result of the system management console 206 facilitating management of IP address detection for the computing systems 210 (without the host server 222 performing/conducting host operating system based inventory of the computing systems 210), the host IP address information is kept up-to-date at the respective BMC 240; the host IP address information is kept-up-to date at the storage device 208; detection of the IP address is performed without requiring any agent of the operating system of the host server 222 and/or the computing system 210 to perform such detection; and detection of the IP address without requiring the need for host OS credentials of the host server 222.

FIG. 3 illustrates a flowchart depicting selected elements of an embodiment of a method 300 for managing internet protocol (IP) address detection. The method 300 may be performed by the information handling system 100, the information handling system 202 and/or the system management console 206, and with reference to FIGS. 1-2. It is noted that certain operations described in method 300 may be optional or may be rearranged in different embodiments

Specifically, the system management console 206 can obtain a media access control (MAC) address of each of the computing systems 210, at 302. In particular, the system management console 206 can obtain the MAC address from the BMCs 240 of each of the computing systems 210. That is, during “on-boarding” of the computing systems 210, the system management console 206 can obtain the MAC addresses of the computing systems 210 from respective BMCs 240.

The system management console 206 can store a database table 250 that indicates the MAC addresses for each of the computing systems 210, and 304. In particular, the storage device 208 can store the database table 250, and provide access to the database table 250. The database table 250 can indicate, for each of the computing systems 210, the MAC address associated with the computing system 210.

The system management console 206 can identify, from the host server 222, one or more messages that are directed to the computing systems 210, at 306. That is, the system management console 206 can “listen” to these messages that are from the host server 222 and directed to the computing systems 210. The system management console 206 can identify the messages from the host server 222 to identify the IP address indicated by each message.

In some examples, the messages from the host server 222 to the computing systems 210 are dynamic host configuration protocol (DHCP) messages. That is, the DHCP messages transmitted from the host server 222 to the computing systems 210 are targeted for specific MAC addresses of the computing systems 210 (the messages that are identified/detected by the system management console 206).

In some examples, the messages from the host server 222 to the computing systems 210 are unicast messages. In some examples, the messages from the host server 222 to the computing systems 210 are broadcast messages. In some examples, the messages from the host server 222 to the computing systems 210 are both unicast messages and broadcast messages.

The system management console 206 can obtain, from each of the messages, a MAC address associated with the message, at 308. That is, the system management console 206 can identify (fetch) the MAC address associated with each of the messages from examination of the messages.

The system management console 206 can compare the MAC address for a particular message (of the messages transmitted from the host server 222 to the computing systems 210) with the MAC addresses stored by the database table 250 for each of the computing systems 210, at 310. Specifically, for a particular message, the system management console 206 can map the MAC address from the particular message to a particular computing system 210 that is indicated as corresponding to the MAC address of the particular message within the database table 250.

The system management console 206 can determine, based on the comparing, whether the MAC address for the particular message is associated with a computing system 210 managed by the system management console 206, at 312. That is, the system management console 206 can determine whether the MAC address from the particular message is mapped (matched) to a particular computing system 210 that is indicated as corresponding to the MAC address of the particular message within the database table 250.

When the system management console 206 determines that the MAC address for the particular message is associated with (matched to) a particular computing system 210 managed by the system management console 206, the system management console 206 can provide the IP address indicated by the particular message to the respective BMC 240 of the particular computing system 210, at 314. That is, the system management console 206 can provide a message to the particular computing system 210 indicating the IP address indicated by the particular message. That is, the IP addresses is associated with the particular computing system 210

When the system management console 206 determines that the MAC address for the particular message is not associated with (not matched with) a particular computing system 210 managed by the system management console 206, the system management console 206 discards the message, at 316.

In some examples, after determining that the MAC address for the particular message is associated with a particular computing system 210 managed by the system management console 206, the system management console 206 can access the particular computing system 210 associated with the MAC address. For example, the system management console 206 can access the particular computing system 210 by transmitting the IP address that is indicated by the particular message to the particular computing system 210 (e.g., through the respective BMC 240).

In some examples, the system management console 206 can update the database table 250 to indicate the IP address for the particular computing system 210 that is identified as associated with the MAC address for the particular message. That is, the system management console 206, for the particular computing system 210 that corresponds to the MAC address of the message from the host server 222, can update the database table 250 to indicate the IP address that corresponds to the particular computing system 210 and the MAC address.

In some examples, the system management console 206 can update the respective BMC 240 of the particular computing system 210 to indicate the IP address for the particular computing systems 210. That is, the system management console 206, for the particular computing system 210 that corresponds to the MAC address of the message from the host server 222, can update the respective BMC 240 to indicate the IP address that corresponds to the particular computing system 210 and the MAC address at the respective BMC 240.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated other-wise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A computer-implemented method of managing internet protocol (IP) address detection, the method comprising:
obtaining, by a system management console that manages multiple computing systems, a media access control (MAC) address of each of the computing systems from a respective baseboard management controller (BMC) of each of the computing systems;
storing, by the system management console, a database table indicating the MAC address for each of the computing systems;
transmitting, by a host server over a first network, one or more messages that are directed to one or more of the computing systems of the multiple computing systems;
performing, by the system management console, an IP address detection of the computing systems, wherein the system management console is separate and distinct from the host server, including:
detecting, for each message that is transmitted by the host server that are directed to one or more of the computing systems, an IP address indicated by the message, wherein the messages are not directed to the system management console;
obtaining, from each of the messages, a MAC address associated with the message;
comparing, by the system management console, the MAC address for a particular message of the one or more messages with the MAC addresses stored by the database table for each of the computing systems;
determining, based on the comparing, whether the MAC address for the particular message is associated with a particular computing system of the multiple computing systems managed by the system management console;
when it is determined that the MAC address for the particular message is associated with a particular computing system managed by the system management console, providing, by the system management console, the IP address indicated by the message to the BMC of the particular computing system; and
detecting that the IP address has changed, and in response, i) updating the IP address at the respective BMC of each of the computing systems and ii) updating the database table, that is stored by the system management console, to indicate the change of the IP address for the particular computing system,
wherein performing the IP address detection of the computing systems is independent of the host server, that sent the messages, from performing a host operating system-based inventory of the computing systems.

2. The computer-implemented method of claim 1, wherein the one or more messages are unicast messages directed to the one or more of the computing systems, are broadcast message directed to the one or more computing systems, or both.

3. The computer-implemented method of claim 1, further comprising after determining that the MAC address for the particular message is associated with a particular computing system managed by the system management console, accessing the particular computing system associated with the MAC address.

4. The computer-implemented method of claim 1, when it is determined that the MAC address for the particular message is not associated with a particular computing system managed by the system management console, discarding the message.

5. The computer-implemented method of claim 1, wherein the messages are dynamic host configuration protocol (DHCP) messages.

6. (canceled)

7. (canceled)

8. An information handling system comprising a processor having access to memory media storing instructions executable by the processor to perform operations comprising, comprising:
obtaining, by a system management console that manages multiple computing systems, a media access control (MAC) address of each of the computing systems from a respective baseboard management controller (BMC) of each of the computing systems;
storing, by the system management console, a database table indicating the MAC address for each of the computing systems;
transmitting, by a host server over a first network, one or more messages that are directed to one or more of the computing systems of the multiple computing systems;
performing, by the system management console, an IP address detection of the computing systems, wherein the system management console is separate and distinct from the host server, including:
detecting, for each message that is transmitted by the host server that are directed to one or more of the computing systems, an IP address indicated by the message, wherein the messages are not directed to the system management console;
obtaining, from each of the messages, a MAC address associated with the message;
comparing, by the system management console, the MAC address for a particular message of the one or more messages with the MAC addresses stored by the database table for each of the computing systems;
determining, based on the comparing, whether the MAC address for the particular message is associated with a particular computing system of the multiple computing systems managed by the system management console;
when it is determined that the MAC address for the particular message is associated with a particular computing system managed by the system management console, providing, by the system management console, the IP address indicated by the message to the BMC of the particular computing system; and
detecting that the IP address has changed, and in response, i) updating the IP address at the respective BMC of each of the computing systems and ii) updating the database table, that is stored by the system management console, to indicate the change of the IP address for the particular computing system,
wherein performing the IP address detection of the computing systems is independent of the host server, that sent the messages, from performing a host operating system-based inventory of the computing systems.

9. The information handling system of claim 8, wherein the one or more messages are unicast messages directed to the one or more of the computing systems, are broadcast message directed to the one or more computing systems, or both.

10. The information handling system of claim 8, the operations further comprising after determining that the MAC address for the particular message is associated with a particular computing system managed by the system management console, accessing the particular computing system associated with the MAC address.

11. The information handling system of claim 8, when it is determined that the MAC address for the particular message is not associated with a particular computing system managed by the system management console, discarding the message.

12. The information handling system of claim 8, wherein the messages are dynamic host configuration protocol (DHCP) messages.

13. (canceled)

14. (canceled)

15. A non-transitory computer-readable medium storing software comprising instructions executable by one or more computers which, upon such execution, cause the one or more computers to perform operations comprising:
obtaining, by a system management console that manages multiple computing systems, a media access control (MAC) address of each of the computing systems from a respective baseboard management controller (BMC) of each of the computing systems;
storing, by the system management console, a database table indicating the MAC address for each of the computing systems;
transmitting, by a host server over a first network, one or more messages that are directed to one or more of the computing systems of the multiple computing systems;
performing, by the system management console, an IP address detection of the computing systems, wherein the system management console is separate and distinct from the host server, including:
detecting, for each message that is transmitted by the host server that are directed to one or more of the computing systems, an IP address indicated by the message, wherein the messages are not directed to the system management console;
obtaining, from each of the messages, a MAC address associated with the message;
comparing, by the system management console, the MAC address for a particular message of the one or more messages with the MAC addresses stored by the database table for each of the computing systems;
determining, based on the comparing, whether the MAC address for the particular message is associated with a particular computing system of the multiple computing systems managed by the system management console;
when it is determined that the MAC address for the particular message is associated with a particular computing system managed by the system management console, providing, by the system management console, the IP address indicated by the message to the BMC of the particular computing system; and
detecting that the IP address has changed, and in response, i) updating the IP address at the respective BMC of each of the computing systems and ii) updating the database table, that is stored by the system management console, to indicate the change of the IP address for the particular computing system,
wherein performing the IP address detection of the computing systems is independent of the host server, that sent the messages, from performing a host operating system-based inventory of the computing systems.

16. The computer-readable medium of claim 15, wherein the one or more messages are unicast messages directed to the one or more of the computing systems, are broadcast message directed to the one or more computing systems, or both.

17. The computer-readable medium of claim 15, the operations further comprising after determining that the MAC address for the particular message is associated with a particular computing system managed by the system management console, accessing the particular computing system associated with the MAC address.

18. The computer-readable medium of claim 15, when it is determined that the MAC address for the particular message is not associated with a particular computing system managed by the system management console, discarding the message.

19. The computer-readable medium of claim 15, wherein the messages are dynamic host configuration protocol (DHCP) messages.

20. (canceled)

21. The computer-implemented method of claim 1, wherein detecting the IP address indicated by the message includes detecting the IP address without utilizing OS credentials of the host server.
